(19) United States
(12) Patent Application Publication
(10) Pub. No.: US 2014/0368344 A1
(43) Pub. Date: Dec. 18, 2014

(54) CAMERA LENS SENSOR

(71) Applicant: InVue Security Products Inc., Charlotte, NC (US)

(72) Inventors: Jeffrey A. Grant, Charlotte, NC (US); Gary A. Taylor, Fort Mill, SC (US); Christopher J. Fawcett, Charlotte, NC (US)

(21) Appl. No.: 14/301,429

(22) Filed: Jun. 11, 2014

Related U.S. Application Data
(60) Provisional application No. 61/834,098, filed on Jun. 12, 2013.

(51) Int. Cl. G08B 13/14; H04N 5/225

(52) U.S. Cl. CPC G08B 13/14; H04N 5/2251
USPC 340/568.1

(57) ABSTRACT

A sensor for securing a camera and camera lens from theft is provided. For example, the sensor may include a mounting member configured to be secured to a camera having a camera lens engaged therewith. The sensor may also include a movable member operably engaged with the mounting member and configured to move between an engaged position with a camera lens and a disengaged position spaced away from the camera lens. Movement of the movable member away from the lens may be detected and be indicative of a security event.

### CROSS REFERENCE TO RELATED APPLICATIONS

This application claims the benefit of priority to U.S. Provisional Application No. 61/834,098 filed on Jun. 12, 2013, the entire disclosure of which is incorporated herein by reference.

### FIELD OF THE INVENTION

Embodiments of the present invention relate to merchandise security, and, more particularly, to sensors for securing a removable camera lens from theft.

### BACKGROUND OF THE INVENTION

In some cases, a camera lens is more valuable than the camera itself. Camera lens sensors are utilized to protect the theft of the lens, such as an SLR lens, whereby a secondary sensor is attached to the exterior of the lens. However, the secondary sensor typically includes a wire and a sensor that engages the lens such that the user experience is hindered. Some retailers and manufacturers utilize physical blocks to prevent access to the lens and do not rely solely on security of the camera along. One example of this technique is an adapter used to block the button for removing the lens. However, this technique clutters the exterior of the camera and may limit full access to the camera's functionality.

### BRIEF SUMMARY

Embodiments of the present invention are directed to a sensor for securing a camera and camera lens from theft. For example, the sensor may include a mounting member configured to be secured to a camera having a camera lens engaged therewith. The sensor may also include a movable member operably engaged with the mounting member and configured to move between an engaged position with a camera lens and a disengaged position spaced away from the camera lens. Movement of the movable member with respect to the lens may be indicative of removal of the lens in an unauthorized manner.

In other embodiments, a security assembly for securing a camera and camera lens from theft is provided. The assembly includes a sensor comprising a mounting member configured to be secured to a camera having a camera lens engaged therewith and a movable member operably engaged with the mounting member and configured to move relative to the camera lens. The assembly also includes an alarming device in communication with the sensor, wherein the alarming device or the sensor is configured to detect movement of the movable member, and wherein the alarming device is configured to generate an alarming signal in response to movement of the movable member that is indicative of removal of the lens in an unauthorized manner.

In another embodiment, a method for securing a camera and a camera lens from theft is provided. The method includes securing a sensor to a camera, wherein the sensor comprises a movable member. The method further includes positioning the movable member relative to a camera lens engaged with the camera such that movement of the movable member with respect to the lens is indicative of removal of the lens in an unauthorized manner.

In yet another embodiment, a method for securing a camera and a camera lens from theft is provided. The method includes providing a sensor secured to a camera, wherein the sensor comprises a movable member. The method also includes determining a tare value of the movable member and generating an alarming signal based on movement of the movable member and the associated tare value.

In one embodiment, a sensor for securing a camera and camera lens from theft is provided. The sensor includes a mounting member configured to be secured to a camera having a camera lens engaged therewith and a proximity device operably engaged with the mounting member. The proximity device is configured to detect movement of the lens that is indicative of removal of the lens in an unauthorized manner.

In another embodiment, a sensor for securing a camera and camera lens from theft is provided. The sensor includes a mounting member configured to be secured to a camera having a camera lens engaged therewith and a sensing device operably engaged with the mounting member. The sensing device is configured to detect a change in state that is indicative of removal of the lens in an unauthorized manner.

### BRIEF DESCRIPTION OF THE DRAWINGS

FIG. 1 is a perspective view of a sensor secured to a camera according to an embodiment of the present invention.

FIG. 2 is perspective view of the sensor shown in FIG. 1 removed from the camera.

FIG. 3 is a side view of a sensor and a movable member according to one embodiment of the present invention.

FIG. 4 is a perspective view of a lock ring according to an embodiment of the present invention.

### DETAILED DESCRIPTION OF EMBODIMENTS OF THE INVENTION

Embodiments of the present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation and multiple prime notations are used to indicate similar elements in alternative embodiments.

Embodiments of the present invention provide techniques for protecting a removable lens in a retail environment. In some embodiments, merchandise display security devices are configured for use with various types of cameras and other portable electronic items of merchandise including a removable component, such as a removable lens. For example, the merchandise display security device may be suitable for use with cameras and video recorders, such as handheld cameras, tripod mount cameras, single-lens reflex (SLR) cameras, digital single-lens reflex (DSLR) cameras, camcorders, and point-and-shoot cameras. Although the following discussion is made in the context of a security device for a camera, it is understood that the security device is suitable for use with any number of items of merchandise having one or more removable components, such as, for example, mobile phones, tablets, computers, etc. As such, any item of merchandise that includes a removable feature that may not be readily secured with conventional sensors may be used.

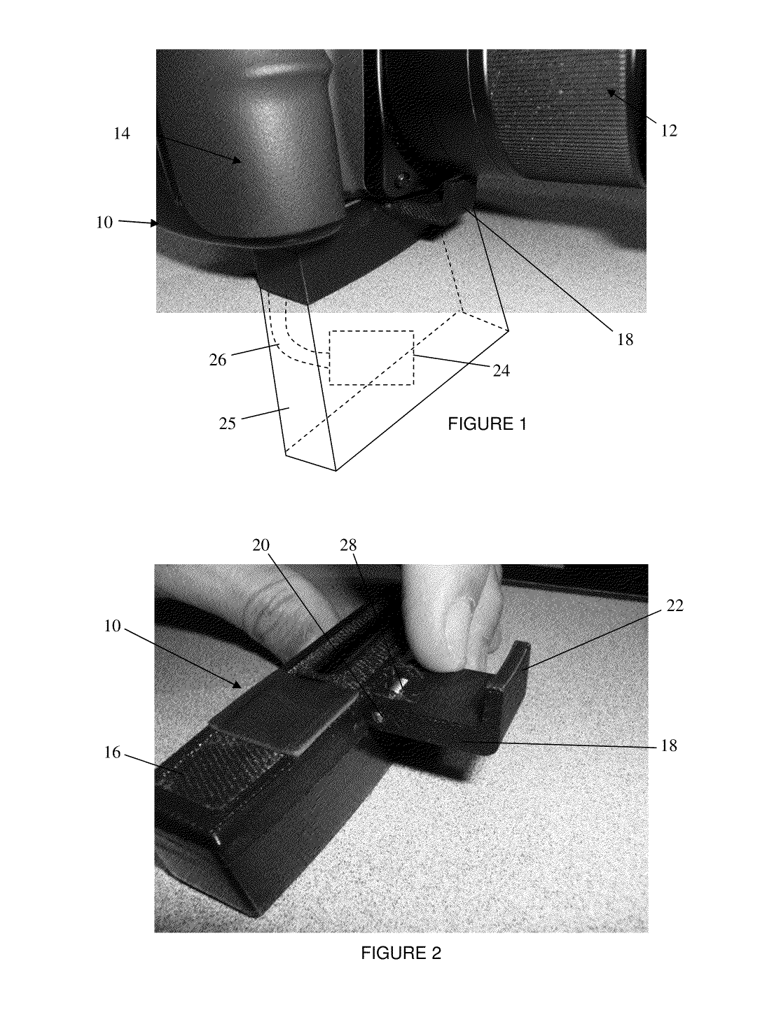

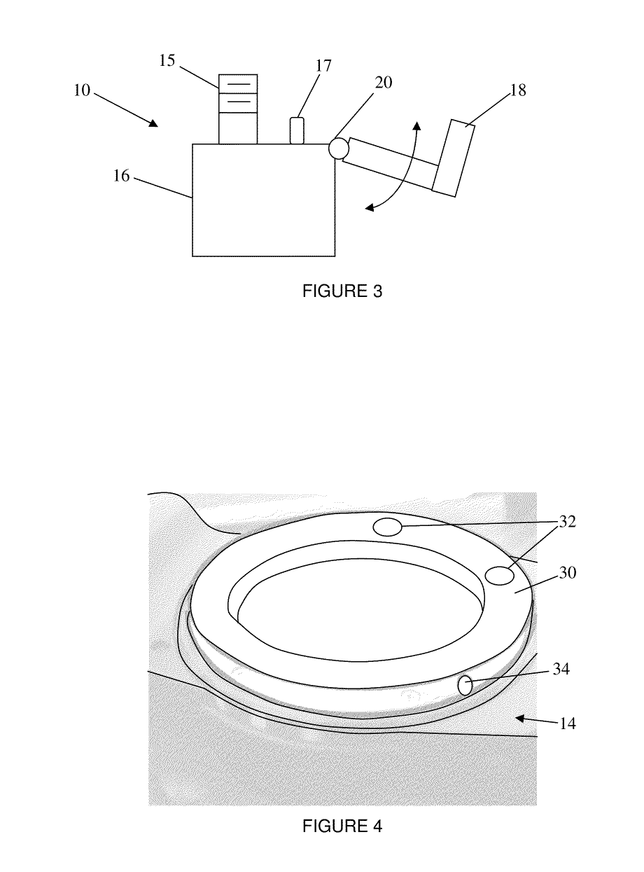

In one embodiment shown in FIGS. 1 and 2, a sensor 10 for sensing a removable lens 12 on a camera 14 is provided. In one example, the camera 14 is attached to a mounting member 16, typically with a fastener 15 or the like that interfaces with the tripod socket or hole on the camera. The mounting member 16 is configured to removably support a camera 14 thereon and may be any suitable size and configuration for interfacing with a camera. In the illustrated embodiment, the mounting member 16 may be generally rectangular in cross section, and an upper surface of the mounting member is configured to engage the camera. The mounting member 16 may include a sensor or pressure switch 17 or the like for interfacing with the camera 14 when secured to the camera (see, e.g., FIG. 3).

Merchandise display security devices suitable for use with the present invention include, but are not limited to, alarm modules and alarming display stands, such as the Series 940, 1000, and 2000 PODs available from InVue Security Products Inc. of Charlotte, North Carolina, USA. According to one embodiment, the merchandise display security device is similar to that disclosed in U.S. Pat. No. 8,674,833 entitled Universal Camera Sensor Having Movable Mount for Retaining Power Connector and U.S. Publication No. 2014/0063238 entitled Camera Sensor Having a Reversible Sensor Housing and Reversible Adapter, the contents of which are hereby incorporated by reference in its entirety. However, those of ordinary skill in the art will readily appreciate that camera sensors and sensors for other types of merchandise constructed in accordance with the present invention are useable with other merchandise display security devices and merchandise display systems.

The sensor 10 may be in communication with an alarming device 24 configured to generate an alarming signal in response to various security events. One such security event is the instance where the camera 14 is removed from the mounting member 16 in an unauthorized manner (e.g., via actuation of a pressure switch 17 or the like disposed on the mounting member). The alarming device 24 may include appropriate electronics or circuitry for detecting security events and generating an appropriate security signal in response thereto. The alarming signal could be any suitable audible, visual, and/or haptic signal. It is understood that the alarming device 24 may be integrated with the sensor 10 in a single standalone component, or the alarming device may be remotely disposed from the sensor and coupled thereto via a cable or other means.

The security device may include a display stand 25 for removably supporting the sensor 10 thereon. The display stand 25 may have any desired size and configuration for receiving and supporting the sensor 10 thereon. In some embodiments, the sensor 10 and display stand 25 may be configured such that the sensor may be positioned on the display stand in one of a plurality of different display positions. The display stand 25 may include one or more magnets or magnetically attractable material that are complementary to one or more magnets or magnetically attractable material in the sensor for facilitating alignment and securement when the sensor 10 is supported on the display stand. Furthermore, the display stand 25 and the sensor 10 may each be provided with complementary external and/or internal geometry features for aligning the sensor relative to display stand in a predetermined desired orientation.

The display stand 25 may contain the alarming device 24 or like monitoring electronics that monitor the state of the sensor 10 for detecting whether the camera 14 is securely attached to the sensor. Thus, the display stand 25 and alarming device 24 may be integrated with one another in some embodiments. Moreover, the display stand 25 may contain an internal power source (e.g., a battery) for providing power to the monitoring electronics and the sensor electronics, or alternatively or additionally, may comprise a power cord that is electrically connected to an external power source, such as a direct current (DC) transformer and an alternating current (AC) electrical outlet.

In some embodiments, the alarming device 24 is configured to be armed and disarmed. For example, the alarming device 24 may be configured to communicate with a key for arming and disarming thereof. In one embodiment, the key is an electronic key. In other embodiments, the key is similar to that disclosed in U.S. Pat. No. 7,737,845 entitled Programmable Key for a Security System for Protecting Merchandise, the contents of which are incorporated by reference herein it its entirety.

In some embodiments, sensor 10 retains a captive, externally-threaded fastener 15 operable for engaging an internally-threaded tripod mount provided on the underside of the camera 14. The sensor 10 may further comprise a pressure switch 17 that is biased in an extended position. As such, pressure switch 17 is configured to move from the extended position to a retracted or depressed position as the fastener 15 secures the camera 14 onto the sensor 10. In the depressed position, the pressure switch 17 completes an electronic monitoring circuit of sensor electronics disposed within the sensor 10 that is electrically connected to monitoring electronics associated with the alarming device 24 to indicate that the camera 14 is securely attached to the sensor. In the event that a potential thief attempts to separate the camera 14 from the sensor 10, for example, by unscrewing the fastener 15, or alternatively, by rotating the camera relative to the sensor housing, biased pressure switch 17 extends and interrupts the monitoring circuit of sensor electronics to indicate that the camera is no longer securely attached to the sensor. In response to the pressure switch 17 changing from a “secured” state to an “unsecured” or “alarm” state, the monitoring electronics of the alarming device 24 may activate an alarming signal to alert store personnel to a possible theft.

As shown in FIG. 1, a cable 26 may extend between the alarming device 24 or display stand 25 and the sensor 10 to electrically interconnect monitoring electronics disposed within the alarming device or display stand with electronics disposed within the sensor. The monitoring electronics may be configured to detect when the cable 26 is cut or removed from the sensor 10 or alarming device 24 or display stand 25 in an unauthorized manner and to generate an alarming signal in response thereto. Thus, the cable 26 may define a sense loop via one or more conductors extending therethrough, wherein interruption of the sense loop results in the generation of an alarming signal.

In one embodiment, the sensor 10 comprises a movable member 18 operably engaged with a mounting member 16 (see, e.g., FIGS. 1-2). In one example, the movable member 18 is a “diving board” that extends outwardly from the mounting member 16 and underneath the lens 12. Thus, the movable member 18 does not interfere with the engagement between the camera 14 and the mounting member 16. The movable member 18 may be pivotally engaged with the mounting member 16 via a pivot 20 so as to be configured to pivot about an axis. The movable member 18 may be configured to pivot towards and away from the lens 12. For example, the movable member 18 may be configured to pivot into and out of engagement with the lens 12. In one embodiment, the movable member 18 may be biased towards the lens 12, such as via a spring 28 engaged with the pivot 20. Therefore, in a relaxed state, the movable member 18 may be biased upwardly towards the lens 12, and engagement of the movable member with the lens may overcome the spring force of the spring 28 to bias the movable member downwardly. The illustrated embodiment shows that the movable member 18 may be generally “L-shaped”, although other shapes may be utilized. In this particular embodiment, the movable member 18 includes a lip 22 that is configured to engage the lens 12.

The alarming device 24 may be configured to detect the presence of the lens 12 based on interaction with the movable member 18 and may be configured to generate an alarming signal (e.g., an audible, visual, and/or haptic signal) if the lens is removed. The movable member 18 need not be physically attached to the lens 12, but may physically touch it or be spaced in close proximity to the lens. Thus, the lens 12 is free to be removed and replaced by a store associate after disarming the alarming device 24. The sensor 10 or alarming device 24 may use various means or devices for detecting the lens 12 including physical proximity, inductance, capacitance, optics, or magnetics. As such, the sensor 10 or alarming device 24 may include any desired sensing means or device that is configured to detect a change in state that is indicative of removal of the lens 12 in an unauthorized manner. In some instances, a tare value is determined when the sensor 10 is armed such that when the tare value is disrupted outside of a tolerance window, an alarming signal will be generated. For example, the movable member 18 may be configured to determine a tare on the rotational position of the movable member when the movable member is engaged with the lens or otherwise positioned for detecting removal of the lens 12. Any movement away from this position would result in generating an alarming signal. A range of allowable movement may be set to any desired sensitivity or tolerance, although an alarming signal may be generated in response to any movement. Thus, in order for a thief to defeat the sensor, a thief would have to hold the movable member 18 in the existing, armed position, while not allowing the movable member to move up nor down. Due to the sensitivity of the sensor 10 and difficulty in holding the movable member 18 stationary, defeating the sensor would be difficult.

In an additional embodiment, the alarming device 24 may be configured to generate a pre-alarm signal. The pre-alarm signal could be used to alert an honest consumer who might be curious about the movable member 18 or sensor 10 that what they are doing will cause an alarming signal. Thus, the pre-alarming signal may encourage the customer to cease the behavior before an actual alarming signal is generated. The pre-alarming signal may be an audible signal, for example, that is generated for a few seconds, but will cease if the consumer returns the sensor to its initial tare state in a pre-set time frame. The pre-alarming signal may have a lower intensity, duration, and/or volume than a full alarming signal.

In another embodiment, a sensor may be disposed in the interface between the camera 14 and the camera lens 12. For example, a pressure switch, plunger switch, or the like may be positioned between the camera 14 and the lens 12. The switch may be operably engaged with the mounting member 18 and be configured to engage the lens 12. The switch may be configured to be compressed or otherwise activated when the lens 12 is secured to the camera 14 thereby closing a circuit in an armed state. Should the lens 12 be removed, the circuit is broken, and the alarming device 24 may be configured to detect the break in the circuit and generate an alarming signal.

In an additional embodiment, a lock ring 30 is disposed between the camera 14 and the lens 12 (see, e.g., FIG. 4). For example, the lock ring 30 may be a circular member that generally corresponds to the cross-sectional shape of the lens 12. The lock ring 30 may be secured to the camera 14 such as via a male threaded engagement. In addition, the lock ring 30 may serve as the female engagement with the lens 12. The lock ring 30 could include one or more contacts 32, pressure switches, or the like that are configured to interface with the lens 12 when the lens is secured to the camera 14. The interaction of the contacts 32 with the lens 30 may allow the lens to electrically communicate with the camera 14 thereby not interfering with the existing functionality of the camera and lens. The lock ring 30 is not accessible to the customer when the lens 12 is secured to the camera 14. Moreover, the lock ring 30 may further include a locking fastener 34 that secures the ring in place on the camera 14 such that a potential thief may not rotate the lock ring. Another locking fastener 34 could be used to ensure that the lens 12 may not be rotated relative to the lock ring 30. The locking fasteners 34 could be any suitable fastener, such a set screw that engages the camera 14 or lens 12 to prevent rotation with respect to the lock ring 30. The locking fasteners 34 may include a proprietary interface that requires a special tool to remove. It is believed that different lock ring 30 configurations may be necessary for different camera 14 and camera lens 12 manufacturers, wherein each camera and lens may have a different interface for engagement therebetween.

Therefore, embodiments of the present invention may provide several advantages. For example, because a sensor may be positioned between the camera and lens, the exterior of the camera may be left uncluttered and all features fully accessible. Adhesives and other attachment devices that are typically required to attach a sensor to the lens are also not required. In addition, the sensor may allow the store associates to easily swap out lenses for customer trial or alternative displays since exterior sensors are not required.

Many modifications and other embodiments of the invention will be readily apparent to one skilled in the art having the benefit of the teachings presented in the foregoing descriptions and the associated drawings. Therefore, it is understood and appreciated that the invention is not to be limited to the specific embodiments disclosed herein, and that modifications to the disclosed embodiments and other undisclosed embodiments are intended to be included within the scope of the appended claims.

That which is claimed is:

1. A sensor for securing a camera and camera lens from theft, the sensor comprising:
a mounting member configured to be secured to a camera having a camera lens engaged therewith; and
a movable member operably engaged with the mounting member and configured to move relative to the lens,
wherein movement of the movable member with respect to the lens is indicative of removal of the lens in an unauthorized manner.

2. The sensor of claim 1, wherein the movable member is configured to pivot with respect to the mounting member.

3. The sensor of claim 2, wherein pivoting of the movable member is indicative of removal of the lens in an authorized manner.

4. The sensor of claim 1, wherein the sensor is configured to detect a change in a tare value of the movable member.

5. The sensor of claim 1, wherein the movable member is configured to move between an engaged position with the camera lens and a disengaged position spaced away from the camera lens.

6. The sensor of claim 5, wherein movement of the movable member away from the lens is indicative of removal of the lens in an unauthorized manner.

7. The sensor of claim 1, further comprising a pressure switch operably engaged with the mounting member and configured to engage the camera.

8. A security assembly for securing a camera and camera lens from theft, the assembly comprising: a sensor comprising:
a mounting member configured to be secured to a camera having a camera lens engaged therewith; and
a movable member operably engaged with the mounting member and configured to move relative to the camera lens; and
an alarming device in communication with the sensor,
wherein the alarming device or the sensor is configured to detect movement of the movable member, and wherein the alarming device is configured to generate an alarming signal in response to movement of the movable member that is indicative of removal of the lens in an unauthorized manner.

9. The assembly of claim 8, wherein the alarming device is configured to generate a plurality of alarming signals having a different intensity, duration, and/or volume.

10. The assembly of claim 8, wherein the movable member is configured to pivot with respect to the mounting member.

11. The assembly of claim 10, wherein the alarming device or sensor is configured to detect pivoting of the movable member that is indicative of removal of the lens in an authorized manner.

12. The assembly of claim 8, wherein the alarming device or sensor is configured to detect a change in a tare value of a rotational position of the movable member.

13. The assembly of claim 8, wherein the movable member is configured to move between an engaged position with the camera lens and a disengaged position spaced away from the camera lens.

14. The assembly of claim 13, wherein the alarming device or sensor is configured to detect movement of the movable member away from the lens that is indicative of removal of the lens in an unauthorized manner.

15. A method for securing a camera and a camera lens from theft, the method comprising:
securing a sensor to a camera, wherein the sensor comprises a movable member; and
positioning the movable member relative to a camera lens engaged with the camera such that movement of the movable member with respect to the lens is indicative of removal of the lens in an unauthorized manner.

16. The method of claim 15, wherein positioning comprises pivoting the movable member.

17. A method for securing a camera and a camera lens from theft, the method comprising:
providing a sensor secured to a camera, wherein the sensor comprises a movable member;
determining a tare value of the movable member; and
generating an alarming signal based on movement of the movable member and the associated tare value.

18. The method of claim 17, wherein determining the tare value comprises determining a rotational position of the movable member.

19. The method of claim 17, further comprising generating an alarming signal in response to movement of the movable member.

20. The method of claim 19, wherein generating comprises generating a plurality of alarming signals having a different intensity, duration, and/or volume.
